(19) United States
(12) Patent Application Publication
(10) Pub. No.: US 2018/0276016 A1
(43) Pub. Date: Sep. 27, 2018

(54) JAVA VIRTUAL MACHINE ABILITY TO PROCESS A NATIVE OBJECT

(71) Applicant: CA, Inc., New York, NY (US)

(72) Inventors: FREDERIC ARMAND HONORE DUMINY, ST. CHARLES, IL (US); DEAN HARRINGTON, OSWEGO, IL (US); JAMMIE PRINGLE, ROMEOVILLE, IL (US); MARY ANN FURNO, SCHAUMBURG, IL (US)

(21) Appl. No.: 15/465,094

(22) Filed: Mar. 21, 2017

(51) Int. Cl. G06F 9/455; G06F 9/54

(52) U.S. Cl. CPC G06F 9/45516; G06F 9/546

(57) ABSTRACT

A Java Virtual Machine (JVM) is enabled to process a data object in common storage. After the data object is received in an address space of an application, an anchor is created in common storage for the data object and the data object is copied into common storage via a Program Call (PC) routine. A notification received at a JVM via a Java Native Interface (JNI) indicates that the data object has been created in the address space of the application and includes a pointer to the data object in common storage. The JVM process, via a Java thread of the JVM, processes the data object in common storage. Upon the Java thread completing processing of the data object, a response is communicated, via the JNI, to a native thread of the JVM. The native thread of the JVM transfers control of the data object back to the PC routine.

### BACKGROUND

A Java Virtual Machine (JVM) provides a sandbox environment for Java applications. In this way, Java applications can be isolated from the local file system and other applications. One advantage this isolation provides is that the Java applications execute in the same fashion regardless of the underlying operating system. Typically, the underlying operating system provides a range of virtual address (e.g., an address space) to the JVM as well as to other applications. In the same way, the operating system may provide a range of virtual address to a common storage that allows applications to transfer objects from one address space to another.

However, once the maximum storage size of a JVM has been allocated, it cannot be increased. In other words, there is no runtime capability that currently exists that enables the maximum storage size of a JVM to be expanded. The inability to dynamically expand the maximum storage size limits the size of a variable object being passed to the JVM through the Java Native Interface. Thus, an application using the JVM for processing a variable data object may fail if a data object is larger than the maximum storage size.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to enabling a JVM to process a data object in common storage. More particularly, after a data object is received in an address space of an application, the data object and a pointer to the data object in the address space of the application is copied into common storage where a JVM is able to process the data object. To do so, an anchor is created in common storage for the data object and the data object is copied into common storage via a Program Call (PC) routine. A notification received at a JVM via a JNI indicates that the data object has been created in the address space of the application and includes a pointer to the data object in common storage. The JVM process, via a Java thread of the JVM, processes the data object in common storage. Upon the Java thread completing processing of the data object, a response is communicated, via the JNI, to a native thread of the JVM. The native thread of the JVM transfers control of the data object back to the PC routine. In embodiments, the JVM can include instructions to perform on the data object in the address space of the application that may instruct the application to release the data object or manipulate at least a portion of the data object.

### BRIEF DESCRIPTION OF THE DRAWINGS

The present invention is described in detail below with reference to the attached drawing figures, wherein:

FIG. 1 is a block diagram showing a system that enables a JVM to process a data object in common storage, in accordance with an embodiment of the present disclosure;

FIG. 2 is a flow diagram showing a method of receiving a data object in an application address space and communicating the address of the data object in a PC Routine, in accordance with embodiments of the present disclosure; and

FIG. 3 is a flow diagram showing a method or receiving an anchor into common storage for the data object and the PC routine, in accordance with embodiments of the present disclosure.

FIG. 4 is a flow diagram showing a method of using a JVM to process the data object in common storage, in accordance with embodiments of the present disclosure; and

FIG. 5 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

As noted in the background, a Java Virtual Machine (JVM) provides a sandbox environment for Java applications. In this way, Java applications can be isolated from the local file system and other applications. One advantage this isolation provides is that the Java applications execute in the same fashion regardless of the underlying operating system. Typically, the underlying operating system provides a range of virtual address (e.g., an address space) to the JVM as well as to other applications. In the same way, the operating system may provide a range of virtual address to a common storage that allows applications to transfer objects from one address space to another.

However, once the maximum storage size of a JVM has been allocated, it cannot be increased. In other words, there is no runtime capability that currently exists that enables the maximum storage size of a JVM to be expanded. The inability to dynamically expand the maximum storage size limits the size of a variable object being passed to the JVM through the Java Native Interface. Thus, an application using the JVM for processing a variable data object may fail if a data object is larger than the maximum storage size.

Embodiments of the present disclosure relate enabling a JVM to process a data object in common storage. More particularly, after a data object is received in an address space of an application, the data object and a pointer to the data object in the address space of the application is copied into common storage where a JVM is able to process the data object. To do so, an anchor is created in common storage for the data object and the data object is copied into common storage via a Program Call (PC) routine. A notification received at a JVM via a JNI indicates that the data object has been created in the address space of the application and includes a pointer to the data object in common storage. The JVM process, via a Java thread of the JVM, processes the data object in common storage. Upon the Java thread completing processing of the data object, a response is communicated, via the JNI, to a native thread of the JVM. The native thread of the JVM transfers control of the data object back to the PC routine. In embodiments, the JVM can include instructions to perform on the data object in the address space of the application that may instruct the application to release the data object or manipulate at least a portion of the data object.

In practice, a mainframe environment may be utilized to provide a variety of services or processes for an organization. In particular, a Java application running in address space of a JVM may be utilized to process data objects received by a server or process running in a different address space (e.g., Simple Mail Transfer Protocol (SMTP) or File Transfer Protocol (FTP) address space). Data objects received by an SMTP or FTP server may be a variety of sizes.

For example, a Java application may be utilized to capture and classify electronic mail (e-mail) traffic. E-mails are communicated in packets that are accumulated into a structured data object. Once the data object is built (i.e., all the packets have been accumulated into the structured data object), the data object can be presented to the JVM for classification.

Normally, the JNI of the JVM is utilized to transfer entire blocks of data (i.e., the data object) between native code and Java code. However, as described above, there is no runtime capability to expand a maximum storage size of the JVM. Because e-mails can be a variety of sizes, it is possible for the data object to exceed the maximum storage size of the JVM, which prevents the e-mail from being classified.

To overcome this obstacle, the native structured object is copied into storage that is compatible with Java storage. As described in more detail below, the address of the compatible structured object is passed to the Java application running on the JVM through the JNI. The Java application is able to navigate the supplied structure through a Java class that allows read access to the native storage.

In embodiments, the JVM is able to transfer instructions back through the JNI which include having the native code update the structure of the data object. Additionally or alternatively, the Java application may notify the native code that the data object has completed processing indicating that the native code may free the local copy of the data object (i.e., in this case, in the SMTP address space).

In this way, the JVM is able to access and manipulate data objects which are outside its address space and exceed the maximum storage size of the JVM. As can be appreciated, even very large external dynamic objects can be processed by the JVM. This allows for increased exploitation of specialty processors (i.e., more Java applications executing on specialty processors due to reduced data transfer in the JNI) which can help decrease the costs of the application provider (e.g., in the example above, the SMTP provider).

Accordingly, one embodiment of the present disclosure is directed to a method that facilitates a JVM processing a data object in common storage. The method comprises receiving notification at a JVM via a JNI that a data object has been created in an address space of an application. The method also comprises processing, via a Java thread of the JVM, the data object in common storage. The method further comprises upon the Java thread completing processing the copy of the data object, communicating a response, via the JNI, to a native thread of the JVM.

In another embodiment of the present disclosure is directed to a method that facilitates an application communicating a pointer to a data object in common storage to a JVM for processing. The method comprises receiving a data object in an address space of an application via an exit routine. The method also comprises, upon the object build completing in the address space of the application, issuing a program call (PC) routine via the exit routine. The method further comprises communicating a pointer to the PC routine. The pointer identifies a location of the data object in the address space of the application. The method also comprises receiving an anchor in common storage for the data object and the PC routine via the PC routine. The PC routine is represented by a work element in the common storage. The work element comprises a pointer to the data object in the common storage. The method further comprises copying the data object into the work element in common storage. The method also comprises communicating the work element to a JVM that wakes up a native thread in address space of the JVM and communicates information, including the pointer to the data object in the common storage to a Java thread via a Java native interface (JNI).

In yet another embodiment, the present disclosure is directed to a computerized system that receives a data object in an address space of an application and process the data object in common storage. The system includes a processor and a non-transitory computer storage medium storing computer-useable instructions that, when used by the processor, cause the processor to receive a data object in an address space of an application via an exit routine. An anchor in common storage is received for the data object and copy the data object into the common storage via a Program Call (PC) routine called by the exit routine. A notification is received at a Java virtual machine (JVM) via a Java native interface (JNI) that the data object has been created in the address space of the application. The notification includes a pointer to the data object in the common storage. Information, including the pointer to the data object in the common storage, is transferred to a Java thread via a Java native interface (JNI). The data object is processed, via a Java thread of the JVM, in the common storage. Upon the Java thread completing processing of the data object, a response is communicated, via the JNI, to a native thread of the JVM. Control of the data object is transferred, via the native thread of the JVM, to the PC routine.

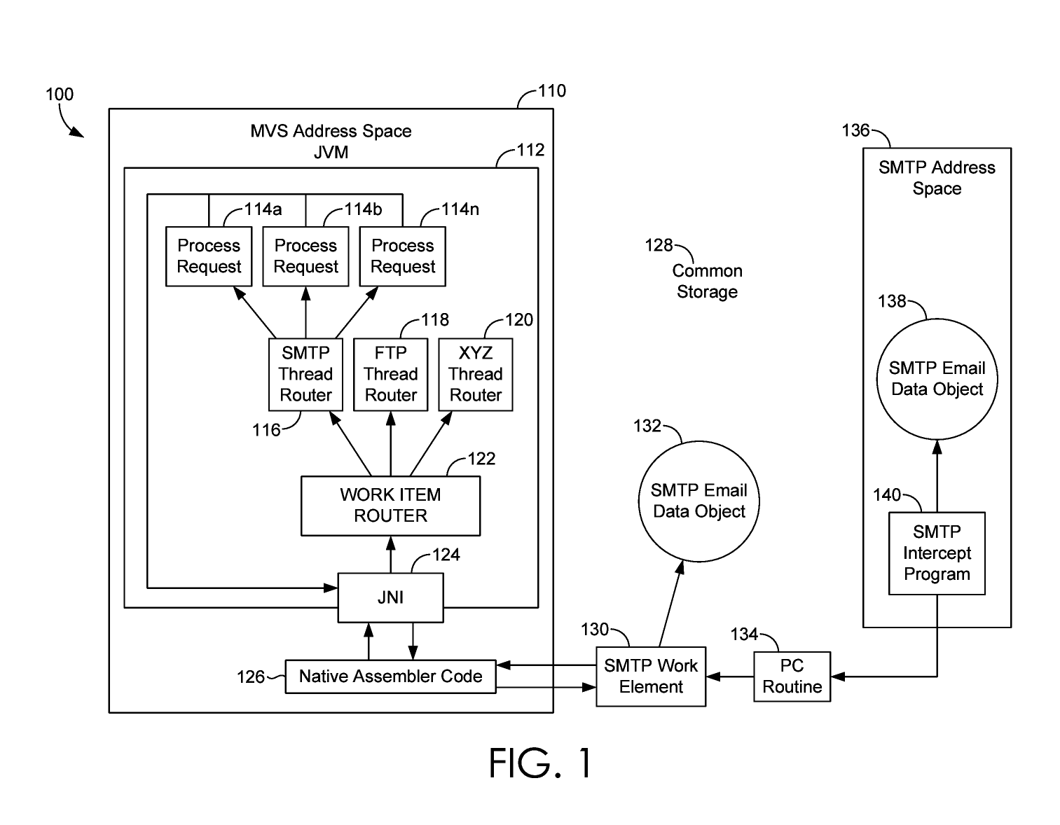

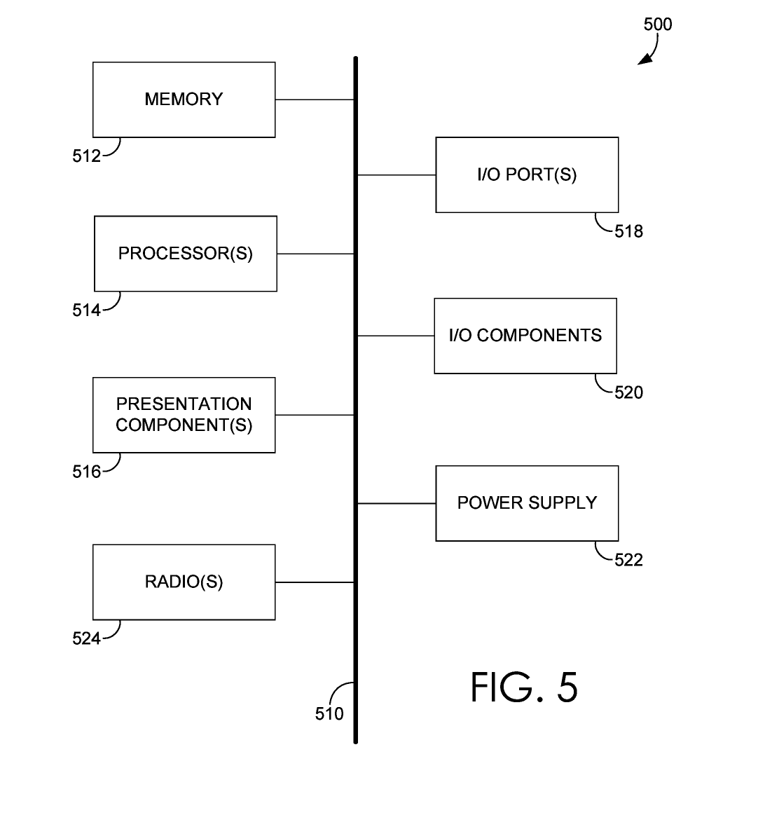

Referring now to FIG. 1, a block diagram is provided that illustrates a JVM processing system 100 that enables a JVM to process a data object in common storage, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The JVM processing system 100 may be implemented via any type of computing device, such as computing device 500 described below with reference to FIG. 5, for example. In various embodiments, the JVM processing system 100 may be implemented via a single device or multiple devices cooperating in a distributed environment.

The JVM processing system 100 generally operates to enable a JVM to process a data object in common storage. In embodiments, the JVM is able to transfer instructions back through the JNI which include having the native code update the structure of the data object. Additionally, or alternatively, the Java application may notify the native code that the data object has completed processing indicating that the native code may free the local copy of the data object. As shown in FIG. 1, the JVM processing system 100 is part of a mainframe environment and includes a JVM 112 in Multiple Virtual Storage (MVS) address space 110, an SMTP server 136 in SMTP address space, and common storage 128. It should be understood that the JVM processing system 100 shown in FIG. 1 is an example of one suitable computing system architecture. Each of the components shown in FIG. 1 may be implemented via any type of computing device, such as computing device 500 described with reference to FIG. 5, for example.

The components may communicate with each other via a network, which may include, without limitation, one or more local area networks (LANs) and/or wide area networks (WANs). Such networking environments are commonplace in offices, enterprise-wide computer networks, intranets, and the Internet. It should be understood that any number of datacenters, monitoring tools, or historical databases may be employed by the JVM processing system 100 within the scope of the present disclosure. Each may comprise a single device or multiple devices cooperating in a distributed environment. For instance, the JVM processing system 100 may be provided via multiple devices arranged in a distributed environment that collectively provide the functionality described herein. Additionally, other components not shown may also be included within the network environment.

In general, a work item originating from an SMTP process is provided to a JVM. Although FIG. 1 illustrates an SMTP process, it is contemplated that any process having a large data object that needs processing in a JVM can benefit from and is within the scope of the present disclosure. The SMTP process (or any other process utilizing the JVM 110) and the JVM 110 may be hosted on a single mainframe. As illustrated, an SMTP process is running in SMTP address space 136. The JVM 112 is running in a MVS address space 110. Any other process utilizing the JVM 110 is running in its own address space. A common storage area 128 hosts a PC routine 134 which will be described in more detail below. A PC routine is a group of related instructions. If the PC routine is space switching, it allows easy access to data in both a primary (i.e., common storage) and a secondary address space (i.e., the SMTP address space).

The JVM 112 can be utilized to securely and efficiently process objects from different processes (e.g., SMTP, FTP) in a mainframe environment. To do so, the JVM 112 provides an infrastructure that enables a plurality of Java processes 114a-114n to run simultaneously to efficiently process objects (e.g., SMTP e-mail data object 138) originating from multiple processes (e.g., SMTP, FTP).

A Java program (a “work item router”) that routes work items (e.g., SMTP work element 130) invokes native assembler code 126 with the JNI 124 to begin monitoring the MVS address space 110 for work items. When a work item is passed to the work item router 122 via the JNI 124, the work item router 122 routes the work item to a corresponding one of a set of class-based work managers (e.g., SMTP thread router 116, FTP thread router 118, XYZ thread router 120). Each of the class-based work managers manages a class of work (e.g., SMTP work, FTP specific work, etc.). When a class-based work manager obtains a work item result and/or instruction, the class-based work manager invokes the native assembler code 126 via the JNI 124. The invoked native assembler code 126 writes the work item result and/or instruction in a designated area of the MVS address space 110 to be retrieved and written to the originating PC routine 134 where it can be communicated back to the originating process.

To illustrate, an FTP process can be used to transfer files between devices. Before sending the files, the files may first be sent to the JVM 112 for pre-processing (e.g., detecting and classifying sensitive data). The JVM 112 may include a Java process running in the JVM 112 that can route work items to a class-based work manager for analysis. For example, JVM 112 may route a work item to an FTP work manager 118 that analyzes the file for sensitive data and masks or marks that sensitive data.

In another example, an SMTP process may be utilized to transfer e-mail objects to other e-mail providers. However, the e-mail objects may first need to be classified to prevent sensitive data from being communicated to other or unauthorized e-mail providers. The e-mail objects may first be sent to the JVM for pre-processing (e.g., detecting and classifying sensitive data). The JVM 112 may include a Java process running in the JVM 112 that can route work items to a class-based work manager for analysis. For example, JVM 112 may route a work item to an SMTP work manager 116 that analyzes the data object for sensitive data and masks or marks that sensitive data.

To do so, initially the JVM 112 registers with the operating system of the mainframe environment. This registration includes creating an anchor in a common storage 128 (e.g., an anchor control block). The anchor in the common storage 128 is a root for work items to be processed by the JVM 112. The anchor may contain information such as a PC routine number, PC location, and status of a PC routine. The location of the anchor is available for discovery by other processes such as SMTP process running in the SMTP address space 136. The JVM 112 generates the PC routine 134 and stores a pointer to the PC routine 134 in a control block. The pointer may include a PC number and a PC location.

In addition, the anchor may also contain information regarding the PC routine 134 authorizations and the runtime environment for the PC routine 134. This setup may include establishing a contract or specification that defines a format or arrangement of a work item such as the parameters to be passed to the PC routine 134. The contract or specification may also include the format and information for work items to be offloaded to the JVM 112. For instance, the anchor may specify expected format and information in a header of the work item. The information includes information used by the work item router 122 to route the work item 130, such as specifying SMTP and/or the particular work manager to handle the work item 130 (i.e. the SMTP thread router 116). In addition, the JVM 112 obtains authority and/or privileges for the PC routine 134 to access the SMTP address space 136 and the MVS address space 110. The JVM 112 carries out this registration with calls to the operating system using the native methods in the native code 126 via the JNI 124.

After establishing the anchor in common storage 128 and obtaining authority and/or privileges for the PC routine 134, the PC routine 134 is in a ready or an active status. The ready or active status means that the PC routine 134 is available to be called. In addition, the JVM 112 invokes a native method of the native code 126 through the JNI 124 to begin monitoring for work items in the MVS address space 110. The invoked native method, for example, can be a MVS WAIT macro.

Continuing the SMTP example, an e-mail is received or communicated in packets which are presented as events. The events are accumulated into a structured data object (e.g., SMTP e-mail data object 138) which can be presented to the JVM 112 for classification. Once the SMTP e-mail data object 138 is built, an SMTP intercept program of the SMTP process 140 issues a PC instruction (i.e., an exit routine) to call the PC routine 134. The PC instruction may contain identifying information of the data object 138 and a PC number of the PC routine 134. The PC number may identify which PC routine to invoke. Once identified, the PC location may be used to identify the location of the PC routine 134 in the common storage 128. Control of the data object 138 may then be passed to the PC routine 134.

A pointer may also be communicated to the PC routine 134 that includes that location of the data object 138 in the SMTP address space 136. The PC routine 134 provides an anchor in common storage 128 for the data object 138 and the PC routine 134. The PC routine is represented in the common storage as an SMTP work element 130 that includes a pointer to the data object in common storage 128. At this point, the PC routine 134 makes a copy of the data object 132 in the SMTP work element 130 in common storage 128. In this regard, the PC routine is a non-space switching PC routine that moves data from private storage (e.g., SMTP address space) to common storage and/or common storage to private storage (e.g., SMTP address space). For example, copying may be performed by using an assembler instruction such as “move with key” (MVCK).

The copying of the data object 132 to the common storage 128 causes generation of a notification. To generate the notification, the PC routine 134 can issue an MVS POST (“POST”). The POST macro is used to notify processes about the completion of an event, which in this case was the creation of the copy of the data object 132 and the SMTP work element 130 in the common storage. Issuance of the POST causes the native method previously invoked by the Java process to “wake up” (i.e., continue execution) and read the SMTP work element 130 in the common storage 128. For instance, an MVS dispatcher (“system dispatcher”) can update an event control block (ECB) to reflect the write of the SMTP work element 130. This ECB update causes the native method of the native code 126 to resume execution. The PC routine then issues an MVS WAIT (“WAIT”) to begin monitoring for the work item result and/or instructions.

The JVM 112 obtains access to the SMTP work element 130 from the resumed execution of the native code 126. A notification may be generated that allows the work item router 122 to detect the work element 130 and assign it to the SMTP thread router 116. The SMTP thread router 116 assigns the SMTP work element 130 to a thread. The thread may come from a thread pool 114a-114n. The thread pool 114a-114n represents one or more threads available for task assignment. The size of the thread pool may be automatically adjusted depending on the number of work elements to be processed. When a work element is submitted and there are no more available threads in the thread pool, a new thread may be generated. The assignment of an SMTP work element 130 to a thread may be implemented by using the classes in the Java Executor and ExecutorService interfaces for example.

Importantly, because the SMTP work element 130 includes a pointer to the data object 132 in common storage 128, and because the common storage is compatible with Java storage, the thread is able to process the data object 132 in common storage 128 without requiring the data object be copied into storage within the JVM 112.

Once the thread finishes processing the data object 132, a response and/or instructions is communicated to the native code 126 via the JNI 124. The native code 126 invokes the PC routine 134 and provides instructions for the SMTP process to perform on the data object 138 in the SMTP address space 136 by issuing a POST macro as stated earlier. Issuance of the POST macro causes the PC routine 134 previously invoked by the SMTP process to “wake up” (i.e., continue execution). The PC routine 134 locates the data object 138 in the SMTP address space 136 and may also use a POST macro which the instructions to be performed on the data object 138. The instructions may include releasing the data object or manipulating at least a portion of the data object in the address space of the application. Control of the data object 138 can then be passed from the PC routine 134 back to the SMTP process in the FTP address space 136.

Although the example illustrates a single work element being offloaded to the JVM 112 for ease of understanding it is contemplated the JVM 112 is designed to handle multiple work elements in the same class and across different classes. Thus, FIG. 1 also depicts an FTP thread router 118 and an XYZ thread router 120 (that may represent another process not described herein). Work elements that utilized the FTP thread router 118 or the XYZ thread router 120 traverse a similar operational path as described above. For example, a data object is copied into common storage by the invoked PC routine, resulting in a work element. The PC routine is invoked by a PC instruction, issued by the responsible process, containing a PC number which is associated with a PC location in the control block. The work element is written to the buffer of the JVM 112 by the native method of the native code 126 via the JNI 124. The work element is routed to the appropriate thread router for processing. The thread router assigns the work element to a thread. After processing, control of the data object is transferred back to the PC routine by the native code 126 via the JNI 124 with instructions for the responsible process to perform on the data object (e.g., release, modify, etc.).

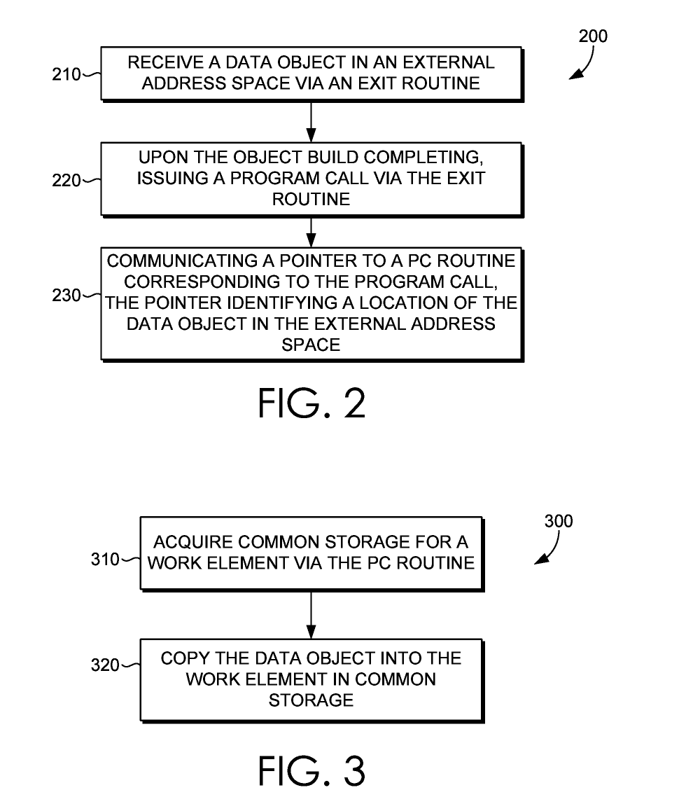

Referring now to FIG. 2, a flow diagram is provided that illustrates a method 200 of receiving a data object in an application address space and communicating the address of the data object in a PC Routine, in accordance with embodiments of the present disclosure. For instance, the method 200 may be employed utilizing the JVM processing system 100 of FIG. 1. As shown at step 210, a data object is received in an SMTP address space via an exit routine. For clarity, an exit routine indicates that the packets comprising an e-mail message have been received.

Although the data object is described as being received in an SMTP address space, it is contemplated that the data object can be any large data object to be processed by a JVM process or application such that processing the large data object is not possible in the storage within the JVM because the large data object exceeds the size allowed by the maximum storage size of the JVM. As such, it is also contemplated that the data object can be received in any address space where the size of the data object may be variable (e.g., SMTP, FTP, and the like).

Once the packets comprising the e-mail message are received, they are accumulated into a structured data object. Upon the object build completing (i.e., the packets being accumulated into the structured data object), a program call is issued via the exit routine, at step 220. A PC routine corresponding to the program call enables the data object to be copied into another address space. In this case, the PC routine enables the data object to be copied into common storage.

At step 230, a pointer to the location of the data object in the SMTP address space is communicated to the PC routine. This pointer can later be utilized by the JVM to instruct the SMTP application to release the data object or manipulate at least a portion of the data object.

Turning now to FIG. 3, a flow diagram is provided that illustrates a method 300 a method of receiving an anchor into common storage for the data object and the PC routine, in accordance with embodiments of the present disclosure. For instance, the method 300 may be employed utilizing the JVM processing system 100 of FIG. 1. As shown at step 310, common storage is acquired via the PC routine.

An anchor in the common storage may be created by the SMTP server when the PC routine is issued. The anchor generally provides a root for items originating in the SMTP address space to be processed by the JVM and is represented by a work element in common storage. As such, the anchor may include information such as the PC routine number, a program call location, and a status of the PC routine. The anchor enables the data object to be copied into the work element in common storage at step 320. The work element also comprises a pointer to the SMTP data object in common storage and can be received in a work queue of the JVM.

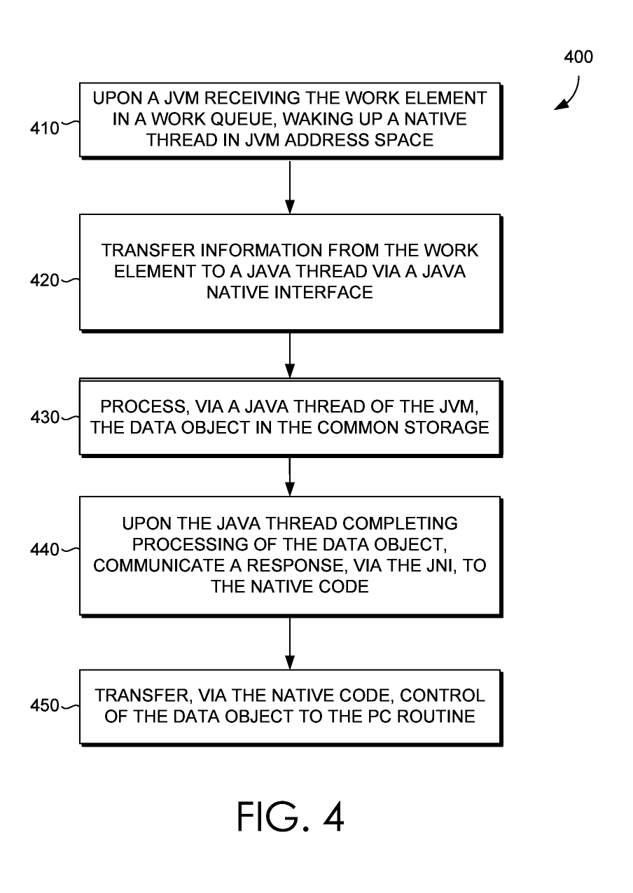

In FIG. 4, a flow diagram is provided that illustrates a method 400 of using a JVM to process the data object in common storage, in accordance with embodiments of the present disclosure. For instance, the method 400 may be employed utilizing the JVM processing system 100 of FIG. 1.

As shown at step 410, upon receiving the work element in a work queue of the JVM, a native thread is waked up in the JVM. The work queue enables the JVM to handle multiple work items. For example, the work queue of the JVM may receive multiple work elements from a SMTP server, an FTP server, and the like for items to be processed by the JVM. The JVM may process the various work elements according to the class or type of request so the appropriate Java process or application can process the request.

The information is transferred, at step 420, from the work element to a Java thread via the JNI. As described above, the JVM may route the work element to the appropriate Java thread corresponding to the type of request (e.g., an SMTP Java thread).

The Java thread of the JVM processes, at step 430, the data object in the common storage. In this way, the Java thread is able to utilize the information provided in the work element to process the data object in common storage rather than inside the JVM. More particularly, the Java thread processes the data object via the JNI by utilizing the pointer to the location of the data object in common storage provided by the work element.

Upon the Java thread completing processing of the data object, at step 440, a response is communicated, via the JNI, to the native code. The native code enables, at step 450, control of the data object to be transferred back to the PC routine. In some embodiments, instructions are provided with the response. The instructions may include directing the SMTP server to release the data object. Alternatively, the instructions may include directing the SMTP server to manipulate at least a portion of the data object in the SMTP address space.

Having described embodiments of the present disclosure, an exemplary operating environment in which embodiments of the present disclosure may be implemented is described below in order to provide a general context for various aspects of the present disclosure. Referring to FIG. 5 in particular, an exemplary operating environment for implementing embodiments of the present disclosure is shown and designated generally as computing device 500. Computing device 500 is but one example of a suitable computing environment and is not intended to suggest any limitation as to the scope of use or functionality of the inventive embodiments. Neither should the computing device 500 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 5, computing device 500 includes a bus 510 that directly or indirectly couples the following devices: memory 512, one or more processors 514, one or more presentation components 516, input/output (I/O) ports 518, input/output (I/O) components 520, and an illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer-storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

As can be understood, embodiments of the present disclosure provide for an objective approach for enabling a JVM to process a data object in common storage. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
receiving notification at a Java virtual machine (JVM) via a Java native interface (JNI) that a data object has been created in an address space of an application;
processing, via a Java thread of the JVM, the data object in common storage; and
upon the Java thread completing processing the copy of the data object, communicating a response, via the JNI, to a native thread of the JVM.

2. The method of claim 2, further comprising transferring, via the native thread, control of the data object to a program call (PC) routine.

3. The method of claim 1, wherein the data object is received in the address space of the application via an exit routine, the data object comprising one or more packets that are accumulated until the data object is built.

4. The method of claim 3, wherein a program call (PC) routine is issued via the exit routine upon the data object being received in the address space of the application.

5. The method of claim 4, wherein a pointer is communicated to the PC routine, the pointer identifying a location of the data object in the address space of the application.

6. The method of claim 5, wherein an anchor is provided in the common storage for the application.

7. The method of claim 6, further comprising copying the data object into the common storage.

8. The method of claim 6, wherein the PC routine is represented by a work element in the common storage that identifies, to the JVM, a location of the data object in the common storage.

9. The method of claim 8, further comprising, upon the JVM receiving the work element in a work queue, waking up the native thread in the JVM.

10. The method of claim 9, further comprising transferring information, including the location of the data object in the common storage to a Java thread via the JNI.

11. The method of claim 1, wherein the data object is a simple mail transfer protocol (SMTP) data object.

12. The method of claim 1, wherein the data object is a file transfer protocol (FTP) data object.

13. The method of claim 1, wherein the response includes instructions to perform on the data object in the address space of the application.

14. The method of claim 13, wherein the instructions include releasing the data object.

15. The method of claim 13, wherein the instructions include manipulating at least a portion of the data object in the address space of the application.

16. A method comprising:
receiving a data object in an address space of an application via an exit routine;
upon the object build completing in the address space of the application, issuing a program call (PC) routine via the exit routine;
communicating a pointer to the PC routine, the pointer identifying a location of the data object in the address space of the application;
receiving an anchor in common storage for the data object and the PC routine via the PC routine, the data object being represented by a work element in the common storage;
copying the data object into the work element of the common storage; and
communicating the work element to a Java virtual machine (JVM) that wakes up a native thread in address space of the JVM and communicates information, including the pointer to the data object in the common storage to a Java thread via a Java native interface (JNI).

17. The method of claim 16, wherein the data object is processed in the common storage via the Java thread of the JVM.

18. The method of claim 17, wherein, upon the Java thread completing processing of the data object, a response is communicated, via the JNI, to the native thread.

19. The method of claim 18, wherein control of the data objected is transferred to the PC routine, via the native thread.

20. A computerized system comprising:
a processor; and
a non-transitory computer storage medium storing computer-useable instructions that, when used by the processor, cause the processor to:
receive a data object in an address space of an application via an exit routine;
receive an anchor in common storage for the data object and copy the data object into the common storage via a Program Call (PC) routine called by the exit routine;
receive a notification at a Java virtual machine (JVM) via a Java native interface (JNI) that the data object has been created in the address space of the application, the notification including a pointer to the data object in the common storage;
transfer information, including the pointer to the data object in the common storage to a Java thread via a Java native interface (JNI);
process, via a Java thread of the JVM, the data object in the common storage;
upon the Java thread completing processing of the data object, communicate a response, via the JNI, to a native thread of the JVM;
transfer, via the native thread of the JVM, control of the data object to the PC routine.
